(19) United States
(12) Patent Application Publication
(10) Pub. No.: US 2011/0204051 A1
(43) Pub. Date: Aug. 25, 2011

(54) INTERLOCKING CONTAINERS

(76) Inventor: E. Timothy Pawl, West Bloomfiled, MI (US)

(21) Appl. No.: 13/031,640

(22) Filed: Feb. 22, 2011

Related U.S. Application Data
(60) Provisional application No. 61/306,017, filed on Feb. 19, 2010.

(51) Int. Cl. B65D 21/02; B23P 19/00

(52) U.S. Cl. 220/23.83; 29/428

(57) ABSTRACT

A storage container system including a plurality of containers of various sizes and having interlocking features for minimizing shipping and storage space for the containers. Each container has an open interior, a top surface, a bottom surface, a front surface, a rear surface, and two side surfaces. A closure device is disposed on the top surface of the container for allowing access to the open interior of the container, and the bottom surface defines a bottom indent pocket for interlocking with the closure device of another container. A handle is disposed on the front surface of the container, and the rear surface defines a rear indent pocket for interlocking with the handle of another container.

### CROSS REFERENCE TO RELATED APPLICATION

This Application claims the benefit of U.S. provisional application Ser. No. 61/306,017, filed on Feb. 19, 2010.

### STATEMENT REGARDING FEDERALLY SPONSORED RESEARCH

NONE

### FIELD OF THE INVENTION

This invention relates generally to interlocking containers and, more particularly, to various sized containers having interlocking features for shipping and storage.

### BACKGROUND OF THE INVENTION

Numerous containers are well known for shipping and storing materials of all kinds. Typically, these containers have exterior shapes to facilitate marketing, shipping and storage of the product. The most common shapes are tubes, squares and rectangles. Additionally, common shapes include rounded corners and edges, which are provided to mainly distinguish a particular product from those of competitive products, i.e. for aesthetic reasons.

A common problem with typical containers is that they do not nest well for shipping or storage, and even more problematic is that they do not interlock for shipping and storage. A large cost related to products is the cost to ship the product from the manufacturer to the retailer. Any space between the products when they are shipped results in less efficient shipping. Since shipping large quantities usually requires the filling of a container or a portion of a container, any space that is not filled still has a cost associated with it. For example, the space between and above containers, the air, is still shipped at the same cost as the containers.

Another common problem is the difficulty in storing containers of various materials. Due to the fact that typical containers do not nest or even interlock together, unnecessary storage space is wasted. Even further, while many containers can be recycled depending on the material they are made of, the reusability of storing containers is generally limited.

There remains a significant and continuing need for improved containers that save shipping space, are cheap to produce, are easy to handle and are reusable.

### SUMMARY OF THE INVENTION

In general terms, this invention provides various sized containers having interlocking features for minimizing shipping and storage space and to provide for the aesthetic nesting and interlocking of containers. Each container has an open interior for containing any type of material normally stored in containers such as, for example, salt, cereal, milk, spices, dog food, plastic pellets, vehicle motor oil, dish washing liquid, etc. Each container has a first pair of surfaces extending in parallel relationship with one another and a second pair of surfaces extending in parallel relationship with one another. Each of the first and second pairs of surfaces includes a connector for interlocking with other containers. The first pair of surfaces are non-parallel to the second pair of surfaces for allowing the containers to interconnect with one another in at least two non-parallel directions. Each container may interconnect with other containers of various sizes and various dimensional volumes, e.g. quart, half gallon, gallon, etc.

Preferably, one of the connectors on each of the containers is a closure device, which is a cap on a spout in the Figures, for the receipt and discharge of material. The closure device is illustrated as a cap on a spout, but could be any number of closures, such as for example a snap top that closes almost the entire top of the body, like a food storage container, etc. Preferably, another of the connectors on each of the containers also is at least one indent pocket for receiving the closure device of another container to interconnect the containers.

The other connectors of each container are preferably a handle and another indent pocket. Like the closure device, the handle also acts as an interlocking protrusion for receipt within an indent pocket on the side another container opposite the handle.

The indent pockets are configured to tightly receive either the closure device or the handle to lock, or interconnect, two adjacent container bodies together, or the indent pockets can be configured to loosely receive the closure device or the handle if desired.

When compared to other containers, the interlocking containers of the present invention require significantly less space in a vehicle for shipping because the amount of space between containers is minimized, and therefore, shipping costs are reduced when compared to prior art containers. The transportation of the prior art containers generally includes the use of an outside box of material, usually of cardboard. The interlocking containers of the present invention, by their very nature, could be shipped without such a box. The interlocking containers could be constrained with a shrink-wrap film material for further weight and cost savings when compared to the prior art containers. Further, when the containers are interlocked together, they are easier to transport and handle than separated containers. Moreover, containers of various sizes and of various products can be interlocked to one another to further reduce the amount of space wasted between different kinds and sizes of containers.

Even further, the containers of the present invention can be reused for a wide variety of applications. For example, once the contents of a plurality of containers has been consumed, the containers could be filled with sand or any other material and interconnected together to form a wall. This wall could be useful as a barrier to protect against flooding or could be used to build a structure, e.g. a fence or a cabin. If the containers are used to build a structure, transparent containers could be used as windows to allow light to enter the structure.

These and other features and advantages of this invention will become more apparent to those skilled in the art from the detailed description of a preferred embodiment.

### BRIEF DESCRIPTION OF THE DRAWINGS

FIG. 1 is a perspective view of one of the exemplary embodiments of the containers;

FIG. 2 is another perspective view of one of the exemplary embodiments of the container;

FIG. 3 is a perspective view showing a plurality of containers of various sizes and arranged in a sample configuration for locking them together;

FIG. 4 is side view of a plurality of interlocking containers of various sizes;

FIG. 5 is a side view illustrating a plurality of interlocking containers of various sizes locked together; and

FIG. 6 is a cross-sectional view of an exemplary embodiment of the container taken along line 6-6 of FIG. 1.

### DETAILED DESCRIPTION OF THE ENABLING EMBODIMENTS

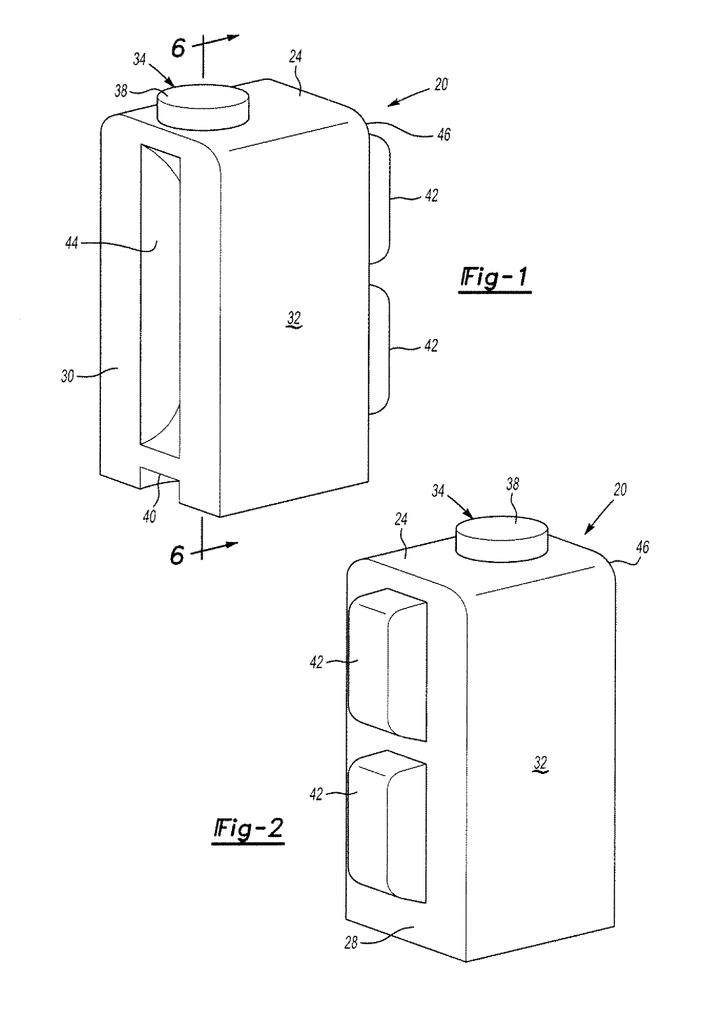

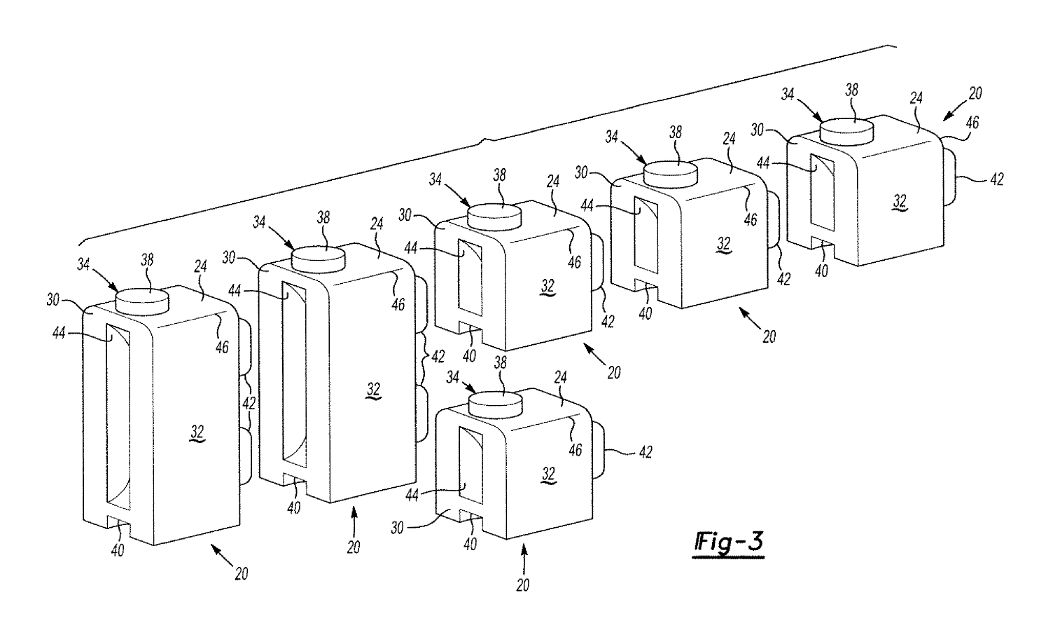

Referring to the Figures, wherein like numerals indicate corresponding parts throughout the several views, an exemplary embodiment of an interlocking container 20 is generally shown in FIGS. 1 and 2. The container 20 has an open interior 22 for storing a material such as, for example, salt, cereal, milk, spices, dog food, plastic pellets, vehicle motor oil, dish washing liquid, etc. The container 20 is preferably blow molded of a polymeric material. However, it should be appreciated that the container 20 can be made of a variety of materials and can be produced using a wide range of forming processes. Exemplary materials that the container 20 could be made of include plastic, paper board, metal, wood, etc.

The container 20 has a first pair of surfaces 24, 26 extending in parallel relationship with one another and a second pair of surfaces 28, 30 extending in parallel relationship with one another. The first pair of surfaces 24, 26 are not parallel with the second pair of surfaces 28, 30. In the exemplary embodiment, the first pair of surfaces 24, 26 are further defined as a top surface 24 and a bottom surface 26, and the second pair of surfaces 28, 30 are further defined as a front surface 28 and a rear surface 30. The container 20 also includes two side surfaces 32. Preferably, the top, bottom, front, rear and side surfaces 24, 26, 28, 30, 32 are all flat to define the container 20 as having a generally parallelepiped shape.

Each of the top, bottom, front, and rear surfaces 24, 26, 28, 30 of the container 20 includes a connector for interconnecting with another container 20. The details of these connectors will be described in further detail below.

As best shown in FIGS. 1 and 2, the connector 34 of the top surface 24 of the exemplary embodiment of the container 20 is a closure device 34, generally indicated, projecting upwardly from the top surface 24. The closure device 34 is movable between an open position for allowing access to the open interior 22 of the container 20 and a closed position for preventing access to the open interior 22 of the container 20. As best shown in FIG. 2, the closure device 34 of the exemplary embodiment is spout 36 with a cap 38 threadedly engaging the spout 36. The container 20 can be filled at the spout 36, and also material within the container 20 can be discharged through the spout 36. Any number of closure devices 34 can be included on a single container 20. As will be appreciated, other closure devices 34 could be used. For example, a larger opening could be provided and a large snap type closure could be used to close the larger opening, like those used in food storage containers 20. If this type of closure device were used, the snap type closure would preferably include protrusions to act as locking members, so that the container could be interlocked to the bottom surface of another container. The container 20 could also include other protrusions 39 spaced apart from the closure device for interconnecting with additional containers 20.

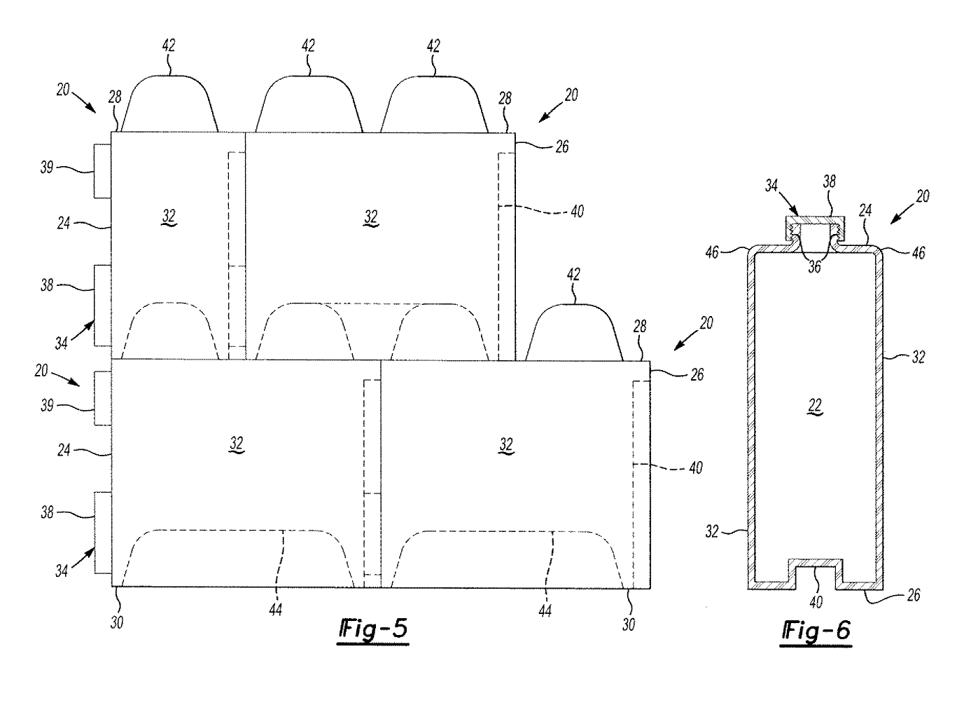

As best shown in FIG. 1, the connector 40 of the bottom surface 26 of the exemplary embodiment of the container 20 is a bottom indent pocket 40. The bottom indent pocket 40 is shaped and adapted to receive the closure device 34 of another container 20. For example, the bottom indent pocket 40 could be rectangularly or cylindrically shaped. It should be appreciated that the bottom indent pocket 40 can take any shape for mating with the closure device 34 of another container 20. As shown in FIG. 5, containers 20 of various sizes can be stacked on each other and interlocked together by engaging the closure device 34 of one container 20 with the bottom indent pocket 40 of another container 20. In the disclosed embodiment, the bottom indent pockets 40 can frictionally receive the closure device 34 to ensure positive interlocking or a larger pocket for looser interlocking can be provided if desired. In the exemplary embodiment, the bottom indent pocket 40 is open at one end so that it can be slid onto the closure device 34 if desired. Any number of bottom indent pockets 40 can be provided on the container 20 for allowing the bottom surface 26 to interlock with more than one other container 20.

As best shown in FIG. 2, the connector 42 of the front surface 28 of the exemplary embodiment of the container 20 is a handle 42. The handle 42 of the exemplary embodiment is generally arc-shaped and arcs away from the front surface 28. However, the handle 42 can take any other shape that allows a person to hold the container 20. The handle 42 has two primary uses: it can be used to carry the container 20 and it also is used to interconnect the container 20 with another container 20 as will be discussed in further detail below. It should be appreciated that any number of handles 42 can be disposed on the front surface 28 of the container 20 or that any other shaped protrusion can be used instead of the handle 42 of the exemplary embodiment.

As best shown in FIG. 1, the connector 44 of the rear surface 30 of the exemplary embodiment of the container 20 is a rear indent pocket 44. The rear indent pocket 44 is shaped and configured to receive the handle 42, or any other projection, on the front surface 28 of another container 20. The rear indent pocket 44 can be configured to tightly receive the handle 42 of another container 20 to interlock two or more containers 20 together, or the rear indent pocket 44 can be configured to loosely interconnect the containers 20 as desired. In the disclosed embodiment, the rear indent pockets 44 are configured as mirror images of the handles 42 so that there is frictional engagement between the walls of the rear indent pocket 44 of one container 20 and the handle 42 of another container 20. Those of ordinary skill in the art will appreciate that in some applications, a frictional lock would be desired and in other applications, a looser interlock would be desired. As shown in FIG. 5, containers 20 of various sizes can be interlocked with one another by inserting the handle 42 of one container 20 into the rear indent pocket 44 of another container 20.

The surfaces 24, 26, 28, 30, 32 of the containers 20 of the exemplary embodiment shown in FIGS. 1 and 2 also include rounded edges 46 joining the various surfaces 24, 26, 28, 30, 32. These rounded edges 46 facilitate the removal of the containers 20 when two or more containers 20 are interlocked with one another. The rounded edges 46 provide a gap for a person to insert his or her fingers to separate two containers 20 when interlocked.

The invention also affords a method of interlocking a pair of containers 20. The method starts with the step of providing a first container 20 and a second container 20 with each container 20 having an open interior 22 and presenting a top surface 24, a bottom surface 26, a front surface 28 and a rear surface 30. The method continues with the step of providing a closure device 34 projecting upwardly from the top surface 24 of each of the containers 20. The method proceeds with the step of providing a bottom indent pocket 40 on the bottom surface 26 of each of the containers 20. The method then proceeds with the step of providing a handle 42 projecting outwardly from the front surface 28 of each of the containers 20. The method then continues with the step of providing a rear indent pocket 44 on the rear surface 30 of each of the containers 20. Next, the method continues with the step of interlocking the handle 42 of the first container 20 with the rear indent pocket 44 of the second container 20 to rigidly interconnect the first and second containers 20.

The method then continues with the step of providing a third container 20 having a top surface 24 and a bottom surface 26 and a front surface 28 and a rear surface 30 and having a bottom indent pocket 40. Next, the method proceeds with the step of interlocking the closure device 34 of the first container 20 with the bottom indent pocket 40 of the third container 20 to rigidly interconnect the first and third containers 20.

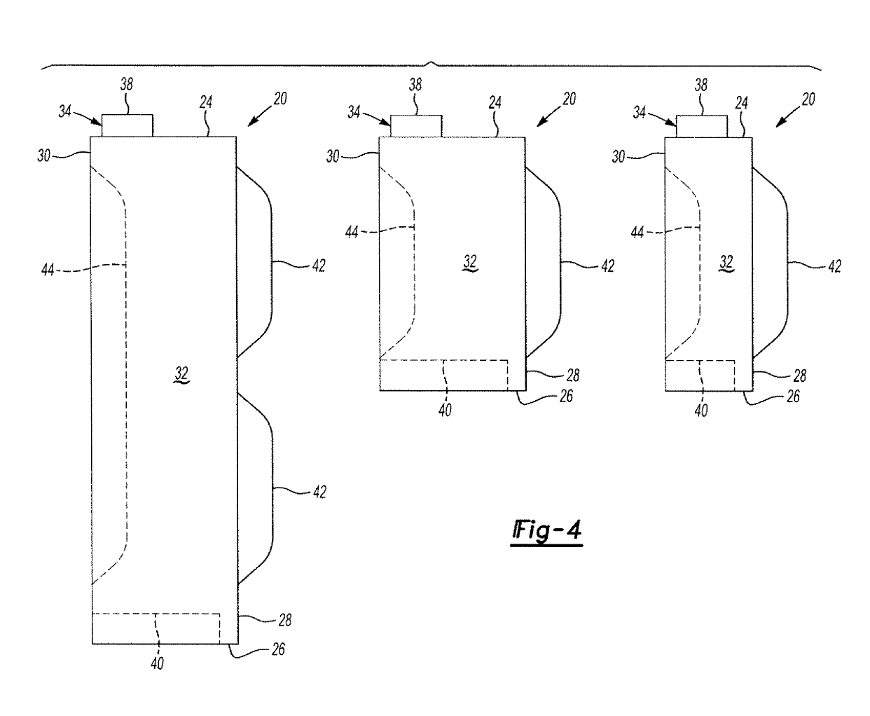

As explained above and shown in FIG. 4, the containers 20 can take various sizes and dimensions. These varying sized containers 20 can interlock with one another so long as the bottom indent pocket 40 of one container 20 is sized to receive the closure device 34 another container 20 or so long as the rear indent pocket 44 of one container 20 is sized to receive the handle 42 of another container 20. This is useful, for example, for companies that sell products in different quantities. The differing quantity containers 20 can be interlocked with one another to minimize space between the containers 20.

As will be appreciated by those of ordinary skill in the art, containers 20 can be interlocked together in various sizes for shipping or storage. Additionally, the containers 20 can be interlocked together to provide the necessary mixing requirements in materials that require specific quantities of different materials to be mixed. In the disclosed embodiment, the largest container 20, shown on the left in FIG. 4, is illustrated as a one (1) gallon container 20 and is ten (10) inches in height, five (5) inches deep and four and three-fifths (4⅗) inches wide. The intermediate container 20, shown in the middle of FIG. 4, is a one half/) gallon container 20 and is five (5) inches high, five (5) inches deep and four and three-fifths (4⅗) inches wide. The smallest container 20, shown on the right in FIG. 4, is illustrated as a one quart container 20 and is five (5) inches high, two and one half (2½) inches wide and four and three-fifths (4⅗) inches deep. It will be appreciated by those of ordinary skill in the art that any number of sizes could be used and still be within the claimed scope of the present invention.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

What is claimed is:

1. An interlocking container structure comprising:
a plurality of containers;
each of said containers having an open interior and presenting a first pair of surfaces extending in parallel relationship with one another and presenting a second pair of surfaces extending in parallel relationship with one another;
each of said first pair of surfaces and said second pair of surfaces including a connector for interlocking with another container; and
said first pair of surfaces being non-parallel with said second pair of surfaces for allowing said containers to interconnect with one another in at least two non-parallel directions.

2. The interlocking container structure as set forth in claim 1 wherein said first pair of surfaces of each container is further defined as a top surface and a bottom surface and wherein said second pair of surfaces of each container is a front surface and a rear surface.

3. The interlocking container structure as set forth in claim 2 wherein each container further includes a pair of side surfaces and wherein said top and bottom and front and rear and side surfaces of each container are flat to define each container as having a generally parallelepiped shape.

4. The interlocking container structure as set forth in claim 3 wherein each container define an angled edge joining said top surface to at least one of said front surface and said rear surface and said side surfaces.

5. The interlocking container structure as set forth in claim 2 wherein said connector on said top surface of each container is a closure device projecting upwardly from said top surface and being movable between an open position for allowing access to said open interior of said container and a closed position for preventing access to said open interior of said container and wherein said connector on said bottom surface of each container is a bottom indent pocket shaped for receiving said closure device of another container.

6. The interlocking container structure as set forth in claim 5 wherein said closure device of each container includes a spout and a cap engaging said spout.

7. The interlocking container as set forth in claim 6 wherein said cap threadedly engages said spout.

8. The interlocking container structure as set forth in claim 6 further including a protrusion spaced apart from said cap.

9. The interlocking container structure as set forth in claim 5 wherein said closure device of one of said containers is disposed in and frictionally engaging said bottom indent pocket of another of said containers to interconnect said containers.

10. The interlocking container structure as set forth in claim 9 wherein said connector on said front surface of each container is a handle and said connector on said rear surface of each connector is a rear indent pocket shaped to receive said handle of another container.

11. The interlocking container structure as set forth in claim 10 wherein said handle of one of said containers is disposed in and frictionally engaging said rear indent pocket of another of said containers to interconnect said containers.

12. The interlocking container structure as set forth in claim 2 wherein said connector on said front surface of each container is a handle and said connector on said rear surface of each connector is a rear indent pocket shaped to receive said handle of another container.

13. The interlocking container structure as set forth in claim 12 wherein said handle of one of said containers is disposed in and frictionally engaging said rear indent pocket of another of said containers to interconnect said containers.

14. The interlocking container structure as set forth in claim 12 wherein said handle of each container is generally arc-shaped and arcs away from said front surface.

15. The interlocking container structure as set forth in claim 1 wherein at least two of said plurality of containers are of different sizes.

16. A method of interlocking a pair of containers comprising the steps of:
providing a first container and a second container with each container having an open interior and presenting a top surface and a bottom surface and a front surface and a rear surface;
providing a closure device projecting upwardly from the top surface of each of the containers;
providing a bottom indent pocket on the bottom surface of each of the containers;
providing a handle projecting outwardly from the front surface of each of the containers;
providing a rear indent pocket on the rear surface of each container; and
interlocking the handle of the first container with the rear indent pocket of the second container to rigidly interconnect the first and second containers.

17. The method as set forth in claim 16 further including the step of providing a third container having a top surface and a bottom surface and a front surface and a rear surface and having a bottom indent pocket; and
interlocking the closure device of the first container with the bottom indent pocket of the third container to rigidly interconnect the first and third containers.

18. The method as set forth in claim 16 wherein the first and second containers have different sizes.

19. The method as set forth in claim 16 wherein the closure device comprises a spout and a cap removably disposed on the spout.
